(19) United States
(12) Patent Application Publication
(10) Pub. No.: US 2005/0182734 A1
(43) Pub. Date: Aug. 18, 2005

(54) Trading system and method for digital commodity

(76) Inventors: Chia Ching Tsai, Taipei (TW); Hsin-Hua Ku, Taipei (TW); Pang Chien Cheng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/911,576

(22) Filed: Aug. 5, 2004

(30) Foreign Application Priority Data
Feb. 16, 2004 (TW) 093103676

(51) Int. Cl. G06F 17/60

(52) U.S. Cl. 705/65

(57) ABSTRACT

A trading system and method for digital commodity are provided. The method comprises encrypting at least one digital commodity to be an encrypted digital commodity in a content distribution center, followed by delivering the encrypted digital commodity to at least one content distribution point through an actual transportation of storage. When a consumer has been selected a desirable-purchased digital commodity, a content distribution card may be carried to one of the content distribution points, and served to store the encrypted desirable-purchased digital commodity via a physical transmission line directly. At this moment, a network transmission line is used to connect with the content distribution center, which may generate a card number-decrypted data based on a card identification code, this card number-decrypted data being further downloaded to the content distribution card. If the consumer is desirous to use the desirable-purchased digital commodity, the content distribution card may be put into a content reader, which allows for restoring the card number-decrypted data and encrypted digital commodity based on the card identification code in order to generate a digital commodity to be read out for use.

### FIELD OF THE INVENTION

The present invention is related to a trading system and method for digital commodity, in which not only the network traffic and the waiting time for downloading with respect to the digital commodity may be reduced, but also a piratical copy of the digital commodity may be prohibited.

### BACKGROUND

Knowledge industry is changing with each passing day as the society is developing, while diverse expressions of knowledge products are also presented. The object of transmitting knowledge massage is effectively attained, no matter paper books, magazines, sound books, records, movies, animations, program software, gaming software, online games, MP3 are used. For the people, the need for these intellectual foods never stops.

Traditionally, a primary way for acquiring knowledge products is spot purchase or spot rental, in such a manner that consumers have to arrive at sites, such as bookstores, record shops, convenience stores, shopping malls, rental libraries, video rental centers, as examples, in person, where the knowledge products are sold or rented, to choose products as well as pay by cash or credit card for the desirable-purchased knowledge products. However, in this trading mode, there still exist disadvantages as follows:
1. Each knowledge commodity is presented as entity, and the production for the physical commodity may waste useful resources, such as mass production cost, as well as paper, compact disk (CD), and so forth.
2. The stock management or cost for transportation with respect to the entity is hard to be reduced effectively, in the case of physical commodity presented as paper.
3. It is difficult to pre-estimate the sales volume of the knowledge commodity previously, such that not only a limited storeroom for commodity may be occupied, but also the resources having been used may be wasted, when it is unsalable.
4. The whole commodity may be invalidated and the consumer should therefore re-buy, even if somewhat of damage is presented in the use of the commodity, such as damage or page fault in a book, which is unfair to the consumer.
5. Mass piratical copy of the knowledge commodity is probable and thus the right enjoyed by a commodity producer is obliterated, which creates an unfair state in society and prohibits vigorous development of the knowledge commodity significantly.
6. The chance of propaganda for knowledge commodity is relatively reduced, due to the incapability of worldwide simultaneous publication or simultaneous sale for the physical commodity.

Moreover, another bargain mode in knowledge industry is principally characterized in that a digital commodity may be formed, from the traditional physical commodity, to be provided for consumers with the convenience of network.

In the above conventional trading method for digital commodity, as illustrated in FIG. 1, various knowledge commodities may be firstly digitized as digital commodities, which may be shown to consumers in all manners of advertisements. Subsequently, in Step 101, the consumer is allowed to choose a desirable-purchased digital commodity as desired. Further, in Step 103, the consumer may contact a content distribution center (CDC) which vends this desirable-purchased digital commodity, and informs it which desirable-purchased digital commodity is selected. Furthermore, in Step 105, the bargain with consumers regarding the price of trade, such as confirmation for buying price, Internet payment, etc., is achieved. Finally, in Step 107, a network transmission line, cable, telephone line, and so forth may be utilized by the consumer directly, so as to store, and then acquire or read out the desirable-purchased digital commodity.

Although the convenience in trading and reduced waste for resources may be obtained in the above trading mode of digital commodity, there still exist disadvantages as follows:
1. Mass piratical copy and sale with respect to a digital commodity is likely occur after it is downloaded and stored, similarly leading to an unfair state in society and significantly prohibiting vigorous development.
2. Network with limited bandwidth is required for directly downloading all digital commodities, which results in an increased transmission time and a probable interruption in transmission process followed by repeated attempt at retransmission, not only merely increasing the inconvenience in data transmission and for consumers, but also wasting time of the consumers for downloading data.
3. In view of the limited bandwidth, it is impossible for a digital commodity with the large volume to be sold and transmitted on network at will, and for mass consumers to online download digital commodities simultaneously, little facilitating a promotion of the digital commodity.

### SUMMARY OF THE INVENTION

Accordingly, how to design a novel trading mode for digital commodity, not only effectively eliminating the limited bandwidth to which the digital commodity transmitted on network is confronted, but also facilitating a promotion of the digital commodity, and additionally effectively lowering the possibility of piratical copy with respect to the digital commodity so as to preserve social justice and protect the right having to be enjoyed by knowledge producer, is the key point of the present invention.

It is the primary object of the present invention to provide a trading system for digital commodity with a reduced risk of being improperly deciphered and thus piratically copied on large scale with respect to the digital commodity, in such a way that not only the social justice may be defended effectively, but also the deserved profit belonging to the knowledge producer may be protected.

It is the secondary object of the present invention to provide a trading system for digital commodity effectively eliminating the problem of limited network bandwidth with respect to data transmission, and significantly reducing the network traffic and waiting time for downloading.

It is another object of the present invention to provide a trading system for digital commodity, whereby not only the purchase rate and read rate of the digital commodity may be calculated more accurately, but also the malady of mass piratical copy with respect to the knowledge commodity may be precluded effectively.

It is still another object of the present invention to provide a trading system for digital commodity capable of easily generating the selected broadcast language for each digital commodity in response to the actual need of a respective consumer, which not only facilitate the popularization of digital commodities, but also provide digital commodities with greater diversity.

It is yet another object of the present invention to provide a trading system for digital commodity effectively designed with a function such that the digital commodity is not easy to be deciphered or copied by means of several security mechanisms: descriptions including registration for a card identification code of a content distribution card, decryption of a card number-decrypted data, and examination whether the card identification code is coincident with the card number-decrypted data by means of a content reader, etc., as well as certificate mechanism provided by the CDC, random generation of the card number-decrypted data or the encrypted digital commodity, and so forth.

It is yet still another object of the present invention to provide a trading method for digital commodity, which not only effectively eliminates the problem of limited network bandwidth with respect to data transmission, but also effectively precluding the crisis of mass copy regarding the knowledge commodity.

For the purpose of achieving aforementioned objects, therefore, a trading system for digital commodity in one preferred embodiment of the present invention mainly at least comprises: a content distribution center (CDC) used for storing at least one digital commodity, each defined with a first part and a second part separately; a plurality of content distribution points storing the first part of the digital commodity via a download path for CDC; and a plurality of content distribution cards connected to the content distribution points via a download path for distribution point, and then allowed to download the first part of at least one digital commodity having been stored in the content distribution point, while download the second part of the digital commodity through the content distribution point and an upload path for distribution point.

For the purpose of achieving aforementioned objects, further, a trading method for digital commodity in another embodiment of the present invention mainly comprises: storing at least one digital commodity into a content distribution center (CDC), and dividing each digital commodity into a first part and a second part; storing the first part of the digital commodity into at least one content distribution point via a download path for CDC; selecting at least one desirable-purchased digital commodity and carrying a content distribution card to the content distribution point, performed by a consumer; and directly downloading the first part of the desirable-purchased digital commodity by the content distribution card from the content distribution point through a download path for distribution point, while downloading the second part of the desirable-purchased digital commodity through the content distribution point and an upload path for distribution point.

### BRIEF DESCRIPTION OF DRAWINGS

FIG. 1 is a flow chart diagram of a conventional trading method for digital commodity;

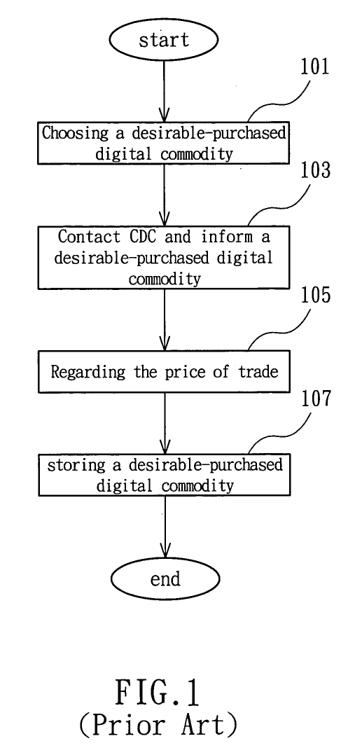

FIG. 2 is a diagram of system architecture of a trading system for digital commodity according to one preferred embodiment of the present invention;

FIG. 3 is a flow chart diagram of a trading method for digital commodity according to the present invention;

FIG. 4 is an architecture diagram of a content distribution card of the present invention; and

FIG. 5 is an architecture diagram according to another embodiment of the present invention.

### DETAILED DESCRIPTION

The structural features and the effects to be achieved may further be understood and appreciated by reference to the presently preferred embodiments together with the detailed description.

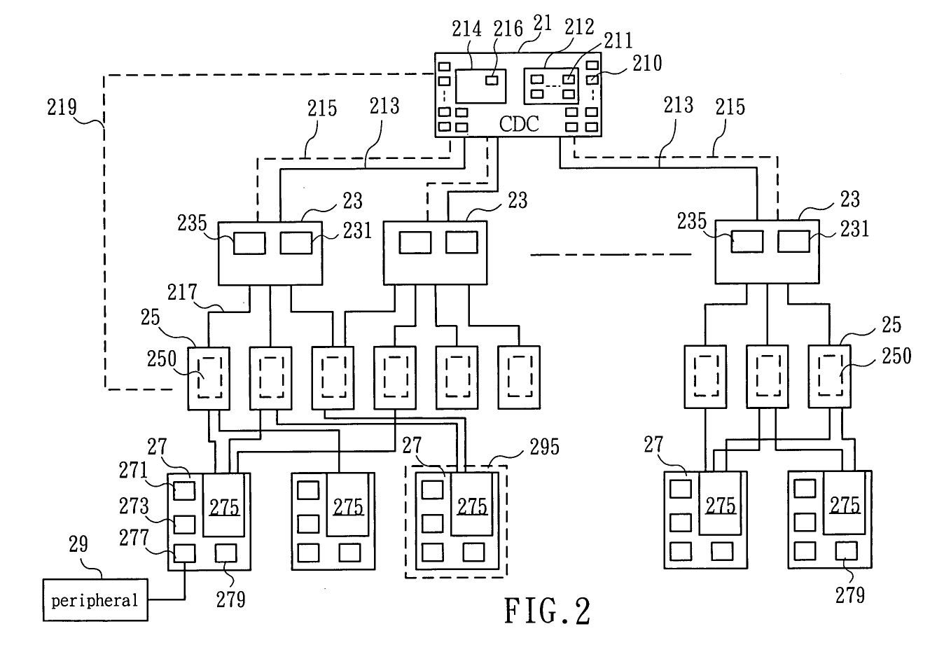

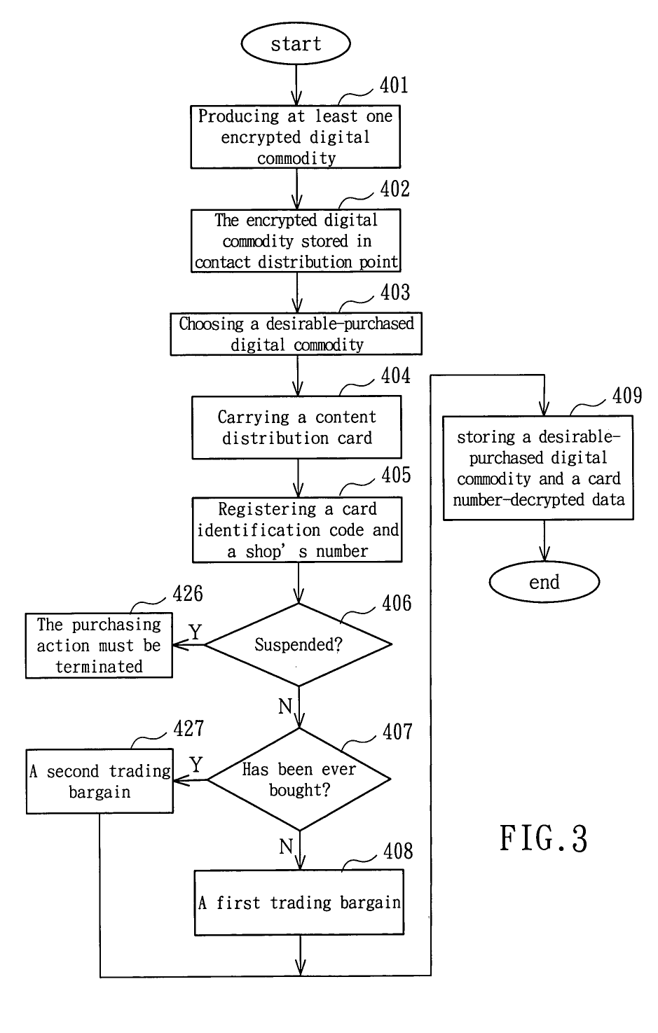

Referring to FIGS. 2 and 3, firstly, there are shown a diagram of system architecture according to one preferred embodiment of the present invention and a flow chart of a trading method, respectively. As illustrated in these figures, the trading method of a trading system for digital commodity 20 comprises the steps as follows:

In Step 401, various knowledge commodities, such as books, comics, animations, movies, television programs, records, MP3, program software, and gaming software are initially digitized to be at least one digital commodity 210 and then stored in a content distribution center (CDC) 21. Afterward, the digital commodity 210 is encrypted by the CDC in order to produce at least one encrypted digital commodity 211, and subsequently, this encrypted digital commodity 211 may be stored in storage for encrypted digital commodity 212, which is provided within the CDC 21. In addition to the storage for encrypted digital commodity 212, at least one storage for registration 214 may be further provided in the CDC 21.

In Step 402, the encrypted digital commodity 211 stored in the storage for encrypted digital commodity 212 may be previously stored in a storage for encrypted digital commodity 231 of at least one content distribution point 23 via a download path for CDC 213, this content distribution point 23 including a bookstore, rental library, video rental center, record shop, convenience store, shopping mall, school, and kindergarten.

The download path for CDC 213 may be selected from a physical transmission line, network transmission line, cable, telephone line, and actual transportation of storage, in which the actual direct transportation of storage 213 means that the storage for encrypted digital commodity 212 may be directly carried, in a manner of actual transportation, to each content distribution point 23 to be stored or convertibly stored, whereby the network traffic and waiting time for downloading with respect to the encrypted digital commodity 211 may be reduced. Furthermore, if any one of the physical transmission line, network transmission line, cable, and telephone line is used as the download path for CDC 213, the transmission may be also performed in a more disengaged period of time, such as at deep night or dawn, thereby the object of well using network bandwidth may be equally achieved.

In Step 403, it is available to a consumer that which digital commodities 210 (or encrypted digital commodities 211) are bought, and the consumers may select at least one desirable-purchased digital commodity (250) therefrom.

In Step 404, the consumer may carry a content distribution card 25 to one of the content distribution points 23 in order to perform trading action for the desirable-purchased digital commodity (250; also referred to as desirable-purchased encrypted digital commodity).

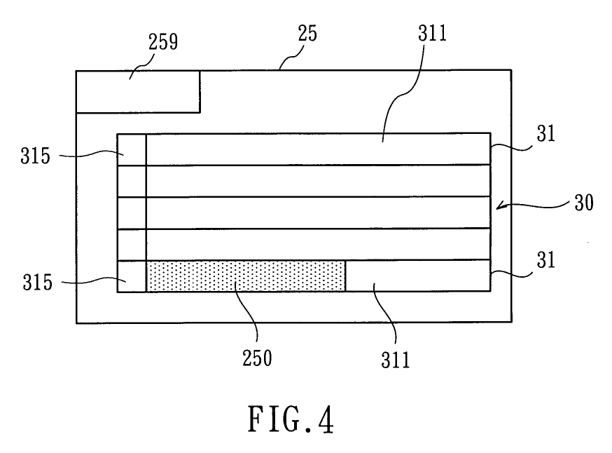

In Step 405, the content distribution point 23 may inform CDC 21 about what is the selected desirable-purchased digital commodity 250 of the consumer via an upload path for distribution point 215, while the CDC 21 may register a card identification code (indicated by 259 in FIG. 4) of the content distribution card 25 intended to shop and a shop's number 235 of the content distribution point 23 intended to be shopped into a storage for registration 214 thereof.

In Step 406, the CDC 21 may examine the card identification code 259 of the content distribution card 25 to further determine if this content distribution card 25 has been suspended? If not, the procedure will proceed to Step 407; if so, which means that a bad record is marked possibly owing to an abnormal trading action, it is necessary to inform the content distribution point 23 and the desirable-purchasing consumer that this purchasing action must be terminated, as illustrated in Step 426.

For each content distribution card 25, as shown in FIG. 4, an individual card identification code 259, like the identity data of this content distribution card, is provided therein, while this card identification code 259 should be uploaded to the CDC 21 for registration in each purchasing action. Thereby, an abnormal trading action may be determined, and even a counterfeit card may be suspected rationally, if a plurality of content distribution cards 25 with the same card identification code 259 execute purchasing action at the same time; or the content distribution cards 259 with the same card identification code 259 appear at different content distribution points 23 apart from each other distantly in a very short period of time; or the content distribution cards 25 with the same card identification code 259 request to buy the same desirable-purchased digital commodity 250 constantly, etc. In this case, any subsequent purchasing action performed by the use of the content distribution card 25 having that card identification code 259 recorded therein is terminated. Thus, the malady of mass piratical copy with respect to the knowledge commodity may be precluded effectively.

In Step 407, with the notification from a consumer or the examination process provided by the CDC 21, whether the content distribution card 25 has been ever bought the desirable-purchased digital commodity 250 may be determined. If so, the process may proceed to Step 427; if not, it will go to Step 408.

In Step 427, if the current desirable-purchased digital commodity 250 has been ever bought before in a non-abnormal trading situation, it means that possible damage in the previously bought digital commodity 250 or another reason resulting in unreusability emerges. Based on the principle of consumer's service and social justice, a second trading bargain, such as re-buying the desirable-purchased digital commodity 250 without charge or with a lower price, may be performed, and the process will go to Step 409. As such, an imperfection, in which an immediate re-buy or discard is required once slight damage occurs in content, the same as the conventional trading mode for knowledge commodity, may be eliminated. In this manner, not only well-used resources, but also consumer's protection may be achieved.

Step 408 presents a normal trading action, where a first trading bargain for purchasing, such as the determinations for price and type of payment, as examples, may be completed in accordance with a normal process. Due to direct access to the content distribution point 23, the way for trading, such as cash, credit card, and Internet credit card, for example, may be selected by a consumer for the purchasing action, differing from a single choice of Internet credit card in the conventional trading mode of the digital commodity. Therefore, the possible dispute and unsafety derived from Internet payment may be effectively reduced.

In Step 409, the bargain is completed, and the content distribution card 25 of the consumer may download the desirable-purchased digital commodity 250 (also referred to as desirable-purchased encrypted digital commodity) stored in the storage for encrypted digital commodity 231 of the content distribution point 23 directly via a download path for distribution point 217. Furthermore, an upload path for distribution point 215 of the content distribution point 23 is then used to connect with the CDC 21, while this CDC 21 may generate a card number-decrypted data (as indicated by 315 in FIG. 4) based on the card identification code 259 and a decrypting program 216 previously stored in the storage for registration 214, where the card number-decrypted data 315 is only applicable to that content distribution card 25 and that desirable-purchased digital commodity 250.

After the desirable-purchased digital commodity 250 has been stored in the content distribution card 25 of the consumer, of course, a direct connection to the CDC 21 is established directly via an upload/download path for distribution card 219, so as to download and then store the card number-decrypted data 315 without the further need for the content distribution point 23. This trading mode may facilitate the activity of worldwide simultaneous release or vendition with respect to a digital commodity. Due to the fact that the card number-decrypted data 315 downloaded online is not a large data or program, the downloading time or transmission capacity therefor is thus reduced significantly compared with the conventional digital commodity. In this manner, a predicament of insufficient bandwidth in transmission network is not probable, facilitating the promotion of the digital commodity.

Moreover, for the generation of the card number-decrypted data (315), a recombination on demand (following a certain logical fashion) based on data, such as date, time, number of times of downloading, and so forth, or randomness (without following a certain logical fashion) is also possible for the CDC 21 to generate this card number-decrypted data (315), in addition to the means based on the card identification code 259 and the decrypting program 216 previously stored in the storage for registration 214. Thereby, the difficulty in deciphering data is obtained.

The aforementioned upload path for distribution point 215, download path for distribution point 217, and upload/download path for distribution card 219 are all selected from the group consisting of a physical transmission line, network transmission line, cable, telephone line, and actual transportation of storage A preferable choice for the download path for distribution point 217, however, may be the physical transmission line, such as data transmission line, USB cable, and RS232 transmission line, as examples, due to the data transmission speed of approximately 400 Mb/s thereof, by which, much higher than the network transmission rate of 1.5 Mb/s, the desirable-purchased digital commodity 250 is thus stored into the content distribution card 25 of the consumer in a considerably short period of time.

Furthermore, it is preferable to select the network transmission path, cable, or telephone path as the upload path for distribution point 215 and upload/download path for distribution card 219, owing to its capability for the connection with a remote CDC 21. In addition to the registration for the card identification code 259 of the content distribution card 25, and the shop's number 235 of the content distribution point 23, the card number-decrypted data 315, cooperated with the desirable-purchased digital commodity 250, is also downloaded accordingly.

Further, each time a consumer chooses the desirable-purchased digital commodity 250, the connection with the CDC 21 is required in order to download the card number-decrypted data 315. Without the decryption provided by the card number-decrypted data 315, it is impossible for the whole desirable-purchased digital commodity 250 to be decrypted or read out for use. Therefore, the difficulty in deciphering and copying the digital commodity 210 may be effectively raised.

It is necessary for the consumer, who is ready for using or reading out the desirable-purchased digital commodity 250, to put the content distribution card 25 having the desirable-purchased digital commodity 250 stored therein into a card-accommodating area 275 of a content reader 27. A card number-examining device of the content reader 27 may be used to examine whether the card number-decrypted data 315 of the content distribution card 25 is coincident with the card identification code 259? If so, a data processing device 271 is further used in order to decrypt the card number-decrypted data 315 for restoring the decrypting program 216, which is then allowed to decrypt and restore the desirable-purchased digital commodity 250 (encrypted digital commodity 211), in such a way that a complete, readable or usable digital commodity 210 may be generated. If not, on the contrary, the decryption and read for the desirable-purchased digital commodity 250 is terminated.

Therefore, in the present invention, various security mechanisms, such as decryptions including the registration for the card identification code 259 of the content distribution card 25, the decryption for the card number-decrypted data 315, the examination and verification for the compatibility of the card identification code 259 provided by the content reader 27, and so forth; the certificate mechanism provided by the CDC, and the random generation of the card number-decrypted data 315 or the encrypted digital commodity 211, as examples, may be mainly used, in such a way that the function of the complication for deciphering or copying digital commodities is effectively achieved.

Moreover, it is easy to make use of the desirable-purchased digital commodity 250 by means of a peripheral 29, such as a audio/video peripheral, sound peripheral, computer peripheral, digital home appliance, and information appliance peripheral, etc., which is connected to a peripheral interface 277.

This peripheral 29, of course, may be also connectedly provided in the content reader 27 directly for facilitating consumers. Moreover, the content distribution card 25 may be also integrated with the content reader 27 as a single unit. Also, the content distribution card 25 is not limited to a pattern of card, such as Secure Digital (SD) card, Compact Flash (CF) card, SM, MS, Multimedia Memory Card (MMC), PCMCIA (PC card), SmartMedia card, Memory Stick card, and MicroDrive, as examples, while a general hard disk or data storing device is also applicable. A direct installation of the content reader 27 in an information product 295, such as a computer system, portable computer, mobile phone, personal digital assistant (PDA), MP3, digital camera, digital video camera, and digital home appliance, for example, is also possible.

In another embodiment, a (zone for) reader's serial number 279 corresponding to the content distribution reader 25 is also provided in the content reader 27, while one content distribution card 25 is usable only when it is operated in the corresponding content reader 27.

Furthermore, in still another embodiment of the present invention, the content distribution card 25 may be used to upload the card identification code 259 of the content distribution card 25, as well as download and store the desirable-purchased digital commodity 250 and download card number-decrypted data 315. In this manner, not only the object of worldwide releasing or vending digital commodities simultaneously is obtained, but also the convenience for users at remote districts with respect to the purchase of digital commodities may be effectively achieved. Moreover, the advantage of reduced possibility of improperly deciphering and then copying digital commodities is still achieved, due to the fact that the cooperation of the specific content distribution card 25 with the download card number-decrypted data 315 is still required.

Moreover, referring to FIG. 4, there is shown an architecture diagram of a content distribution card according to the present invention. As shown in this figure, the content distribution card 25 comprises at least one content memory 30 and a card identification code 259 used for registering the identity data. Further, in each content memory 30, there may be further roughly divided into at least one downloading field 31, each of which may be respectively provided with a primary memory area 311 and a card number-decrypted data 315, in which the latter is used for recording and storing the decrypting program (216) related to this card identification code 259 and the decryption for the desirable-purchased digital commodity 250. Further, the primary memory area 311 may be used to store the desirable-purchased digital commodity 250.

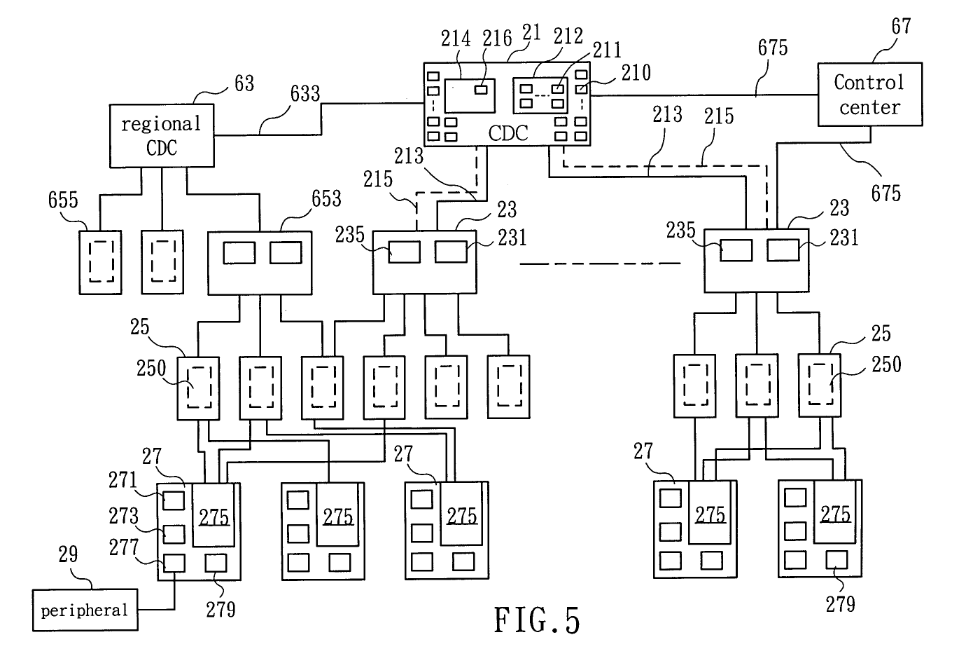

Finally, referring to FIG. 5, there is shown a diagram of system architecture according to still another embodiment of the present invention. Principally, in this embodiment, at least one regional content distribution center 63, shown in this figure and provided at the region far from the content distribution center 21 or having busy business, is equally capable of storing or putting data into at least one storage for encrypted digital commodity 212 and a storage for registration 214 via a download path for regional center 633 (the function of which is the same as that of a download path for CDC 313 described in the previous embodiment). On the other hand, content distribution cards 655 or content distribution points 653 under the government of this regional content distribution center are all allowed to connect thereto in order for downloading the card number-decrypted data 315 of the desirable-purchased digital commodity 250 and the decrypting program 216, without the need for connecting to the CDC 21 any more. Therefore, the network connections to the CDC 21 may be dispersed effectively, and then downloading the desirable-purchased digital commodity may be speeded up.

Further, for meeting the difference in region, and the possible difference in language learning or expression resulted therefrom, the content of some encrypted digital commodities 211 with different kinds of broadcast languages, such as Chinese, Hakka, Holo, Cantonese, English, and Japanese, as examples, may be also designed to meet different actual needs. Also, as a result, different decrypting programs 216 may be downloaded to meet the requirement of consumers, when downloading the storage for registration 214. Thereby, the selected broadcast language may be restored in the process of decryption for the desirable-purchased digital commodity 250, and diversity may be thus provided for consumers.

Also, through a transmission line for control 675, the CDC 21, each content distribution point 23, and regional content distribution center 63 may be connected to a righteous third-party control center 67, which may be a copyright association, non-governmental association, consumer center, and financial center, as examples, allowed to correctly record data of time and price, etc., with respect to each choice for a digital commodity, in such a way that more just and accurate information with regard to the number of sale and read rate, etc., may be provided for knowledge producer, consumers, mass media, or the convenience for statistics and charge may be provided for the industry.

In yet still another embodiment of the present invention, the application in the cable TV system is also possible, in which individual content distribution point 23 is similar to a set-top box or other digital processing device for each household television. In idler time of the cable line, the encrypted digital commodity 211, such as desirable-paid television programs and movies, etc., may be pre-stored in each digital receiving decoder (23). After one desirable-purchased pay cable is selected by a consumer, the card number-decrypted data 315 and the decrypting program 216 used for deciphering this program may be then downloaded by the CDC 21. Thereby, the desirable-paid television program may be selected by the consumer easily.

For the art disclosed in the present invention, again, it is also suitable for an academic organization, such as school and kindergarten, as examples, which is similar to the content distribution center 21, regional content distribution center 63, and content distribution point 653 described in the above embodiments, capable of storing an assigned student's homework, data in communication book and so forth into the content distribution card 25 in the type of encrypted digital commodity 211 and card number-decrypted data 315. In this case, only this content distribution card 25 is required to be carried home by the student. At home, the student's homework and data in communication book may be read out via the card number-examining device 273 and data processing device 271, only the placement of the content distribution card 25 into the content reader 27 is necessary. On the contrary, another encrypted digital commodity 211 may be formed with finished student's homework and responsive massage from the parent to the teacher by the data processing device 271, and then stored in that content distribution card 25 to be carried back to school. Likewise, with the aid of the card number-examining device 273 and data processing device 271 of the content reader 27, the finished homework and massage from student's parent may be read out by the teacher. In addition, even if the aforementioned encrypted digital commodity 211 is lost, the problem of rash data leakage with respect to data may not occur, due to the encryption process provided therefor and the necessary cooperation of the related card number-decrypted data 315 therewith. Thereby, the object of data protection is obtained.

This content distribution card 25 having the student's homework and responsive massage from student's parent stored therein, of course, may be served for uploading that encrypted digital commodity toward the CDC 21 or regional content distribution center 63 through the upload/download path for distribution card 219. As such, statistics or processing, and the subsequent added value with respect to the data offered by the use might be achieved by means of the CDC 21 or regional content on center 63.

Although the desirable-purchased digital commodity 250 has been described in a trading mode of outright sale in the above embodiments, the disclosed art of a trading system and method for digital commodity according to the present invention is also suitable for the digital commodity 210 in a renting mode. For instance, a valid period (renting time-limit) of commodity for renting the digital commodity 210 may be set as one day, one week, one month, and so forth, while another new card number-decrypted data 315 may be generated from the original card number-decrypted data 315 in accordance with this data of renting time-limit. During the renting period (valid period of commodity), a normal operation of the content reader 27 and the content distribution card 25 is remained, while the card number-decrypted data 315 and the desirable-rented digital commodity 210 will be destroy or eliminated automatically once the valid time-limit of commodity is reached. Consequently, the rental action for digital commodity may be then completed.

### LIST OF REFERENCE SYMBOLS

20 trading system for digital commodity
21 content distribution center
210 digital commodity
211 encrypted digital commodity
212 storage for encrypted digital commodity
213 download path for CDC
214 storage for registration
215 upload path for distribution point
216 decrypting program
217 download path for distribution point
219 upload/download path for distribution card
23 content distribution point
231 storage for encrypted digital commodity
235 shop's number
25 content distribution card
250 desirable-purchased digital commodity
259 card identification code
27 content reader
271 data processing device
273 card number-examining device
275 card-accommodating area
277 peripheral interface
279 zone for reader's serial number
29 peripheral
295 information product
30 content memory
31 downloading field
311 primary memory area
315 card number-decrypted data
63 regional content distribution center
633 download path for regional center
653 content distribution point
655 content distribution card
67 control center
675 transmission line for control

1. A trading system for digital commodity, comprising:
a content distribution center (CDC) used for storing at least one decrypting program and at least one encrypted digital commodity generated from a digital commodity by means of an encryption process;
at least one content distribution point storing said encrypted digital commodity via a download path for CDC;
a plurality of content distribution cards connected to said content distribution point via a download path for distribution point, as well as allowed to select and download a desirable-purchased digital commodity from said encrypted digital commodities, and then download said decrypting program corresponding to said desirable-purchased digital commodity via said content distribution point and through an upload path for distribution point; and
at least one content reader allowed for accommodating said content distribution card and performing a decryption process based on said decrypting program for said desirable-purchased digital commodity to restore as said digital commodity to be read out for use.

2. The trading system for digital commodity according to claim 1, wherein said content distribution card is provided with at least one content memory and a card identification code therein.

3. The trading system for digital commodity according to claim 2, wherein said content distribution center comprises at least one storage for encrypted digital commodity for storing said encrypted digital commodity, and at least one storage for registration used for storing said card identification code and said decrypting program, as well as generates a card number-decrypted data based on what selected from the group consisting of said card identification code, date, time, number of times of downloading, valid period of commodity, said decryption process, and the combination thereof.

4. The trading system for digital commodity according to claim 3, wherein said content memory comprises at least one downloading field, each including said card number-decrypted data and a primary memory area for storing said desirable-purchased digital commodity.

5. The trading system for digital commodity according to claim 1, wherein said content reader is provided therein with what selected from the group consisting of a zone for reader's serial number, data processing device, card number-examining device, card-accommodating slot, peripheral interface, audio/video peripheral, sound peripheral, computer peripheral, information appliance peripheral, and the combination thereof.

6. The trading system for digital commodity according to claim 1, wherein said download path for CDC, upload path for distribution point, and download path for distribution point are respectively selected from the group consisting of a physical transmission line, network transmission line, cable, telephone path, actual transportation of storage, and the combination thereof.

7. The trading system for digital commodity according to claim 1, wherein said content distribution card is also allowed to be connected to said content distribution center directly via an load/download path of distribution card, and thus directly download what selected from the group consisting of said decrypting program, said desirable-purchased digital commodity, and the combination thereof, in which said load/download path for distribution card is selected from the group consisting of a physical transmission line, network transmission line, cable, telephone line, actual transportation of storage, and the combination thereof.

8. The trading system for digital commodity according to claim 1, further comprising a regional content distribution center for directly storing said encrypted digital commodity of said digital commodity and said decrypting program via a download path for regional center.

9. The trading system for digital commodity according to claim 1, wherein said content distribution card is also allowed to be selected from the group consisting of a SD card, CF card, SM, MS, MMC, Micro Drive, PC card, SmartMedia card, Memory Stick card, hard disk, content reader, data storing device, and the combination thereof.

10. The trading system for digital commodity according to claim 1, wherein said content distribution card is provided in said content reader and integrated with said content reader as a single unit.

11. The trading system for digital commodity according to claim 1, wherein said content reader is provided in an information product.

12. The trading system for digital commodity according to claim 1, further comprising at least one control center connected to what selected from said content distribution center, content distribution point, and the combination thereof, through a transmission line of control.

13. The trading system for digital commodity according to claim 1, wherein said content distribution point is selected from the group consisting of a bookstore, rental library, video rental center, record shop, convenience store, shopping mall, digital receiving decoder, school, kindergarten, and the combination thereof.

14. The trading system for digital commodity according to claim 1, wherein said content distribution point further comprising a shop's number.

15. A trading method for digital commodity, comprising the steps of:
storing at least one digital commodity into a content distribution center (CDC), and performing an encryption process for each digital commodity to form an encrypted digital commodity, each encrypted digital commodity provided with a corresponding decrypting program;
storing said encrypted digital commodity into at least one content distribution point via a download path for CDC;
selecting at least one desirable-purchased digital commodity from said encrypted digital commodities and carrying a content distribution card to said content distribution point, performed by a consumer;
directly downloading said desirable-purchased digital commodity by said content distribution card from said content distribution point through a download path for distribution point, while downloading said decrypting program corresponding to said desirable-purchased digital commodity through said content distribution point and an upload path for distribution point; and
putting said content distribution card into a content reader and performing a decryption process for said desirable-purchased digital commodity by said decrypting program to restore as said digital commodity to be read out for use.

16. The trading method for digital commodity according to claim 15, further comprising the step of registering what selected from the group consisting of a card identification code of said content distribution card, a shop's number of said content distribution point, and the combination thereof, performed by said content distribution center.

17. The trading method for digital commodity according to claim 16, further comprising the step of generating a card number-decrypted data, performed by said content distribution center, based on what selected from the group consisting of said card identification code, date, time, number of times of downloading, valid period of commodity, said decryption process, and the combination thereof, in which said card number-decrypted data is stored into said content distribution card via said upload path for distribution point.

18. The trading method for digital commodity according to claim 17, further comprising the step of:
examining whether said card number-decrypted data of said content distribution card is compatible with said card identification code by said content reader; If not, terminating the processing and reading of said desirable-purchased digital commodity.

19. The trading method for digital commodity according to claim 15, further comprising the step of determining whether said content distribution card has been suspended; if so, stopping the purchasing action; and if not, proceeding with the purchasing action.

20. The trading method for digital commodity according to claim 15, further comprising the step of determining whether said content distribution card has been ever bought said desirable-purchased digital commodity; if so, completing a second trading bargain; and if not, proceeding to a first trading bargain.

21. The trading method for digital commodity according to claim 15, further comprising the step of directly connecting to said content distribution center via an upload/download path for distribution card, and thus directly download what selected from the group consisting of said decrypting program, performed by consumers.

22. The trading method for digital commodity according to claim 15, wherein said download path for CDC, upload path for distribution point, and download path for distribution point are respectively selected from the group consisting of a physical transmission line, network transmission line, cable, telephone line, actual transportation of storage, and the combination thereof.

23. The trading method for digital commodity according to claim 15, further comprising the step of installing at least one regional content distribution center allowed to directly store said encrypted digital commodity and said decrypting program via a download path for regional center.

24. The trading method for digital commodity according to claim 15, wherein said content distribution card is also allowed to be selected from the group consisting of a SD card, CF card, SM, MS, MMC, Micro Drive, PC card, SmartMedia card, Memory Stick card, hard disk, content reader, data storing device, and the combination thereof.

25. The trading method for digital commodity according to claim 15, wherein said content reader is provided in an information product.

26. The trading method for digital commodity according to claim 15, further comprising at least one control center connected to what selected from said content distribution center, content distribution point, and the combination thereof, through a transmission line of control.

27. The trading method for digital commodity according to claim 15, wherein said content distribution point further comprises a shop's number, and is selected from the group consisting of a bookstore, rental library, video rental center, record shop, convenience store, shopping mall, digital receiving decoder, school, kindergarten, and the combination thereof.

28. The trading method for digital commodity according to claim 15, wherein said content reader is provided therein with what selected from the group consisting of a zone for reader's serial number, data processing device, card number-examining device, card-accommodating slot, peripheral interface, audio/video peripheral, sound peripheral, computer peripheral, information appliance peripheral, and the combination thereof.

29. The trading method for digital commodity according to claim 15, further comprising the step of inputting a digital data into said content reader and performing an encryption process to form another encrypted digital commodity thereby.

30. The trading method for digital commodity according to claim 15, further comprising the step of directly connecting to what selected from said content distribution center, said regional content center, and the combination thereof, and uploading said encrypted digital commodity thereto via an upload/download path for distribution card.

31. The trading method for digital commodity according to claim 17, further comprising the step of checking whether a valid period of commodity is reached all the time by said card number-decrypted data; if so, destroying what selected from the group of said card number-decrypted data, said desirable-purchased digital commodity, and the combination thereof.
